(19) United States
(12) Patent Application Publication
(10) Pub. No.: US 2025/0016668 A1
(43) Pub. Date: Jan. 9, 2025

(54) METHOD AND APPARATUS FOR ESTABLISHMENT OF DATA SESSION CONSIDERING USER SERVICE IN WIRELESS COMMUNICATION SYSTEM

(71) Applicant: Samsung Electronics Co., Ltd., Suwon-si (KR)

(72) Inventor: Kisuk KWEON, Suwon-si (KR)

(21) Appl. No.: 18/764,623

(22) Filed: Jul. 5, 2024

(30) Foreign Application Priority Data
Jul. 5, 2023 (KR) 10-2023-0087020

(51) Int. Cl. H04W 48/18; H04M 15/00; H04W 76/10

(52) U.S. Cl. CPC H04W 48/18; H04M 15/66; H04W 76/10

(57) ABSTRACT

The disclosure relates to a fifth generation (5G) or sixth generation (6G) communication system for supporting a higher data transmission rate. A method performed by a session management function (SMF) in a wireless communication system is provided. The method includes receiving, from a united data management (UDM), a list of user plane function (UPF) functionality components, selecting a UPF based on the list of UPF functionality components, and transmitting, to the selected UPF, a session establishment or modification request message.

### CROSS-REFERENCE TO RELATED APPLICATION(S)

This application is based on and claims priority under 35 U.S.C. § 119 (a) of a Korean patent application number 10-2023-0087020, filed on Jul. 5, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for establishing a data session by considering user services when establishing a data session for transmitting user data.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for effectively providing services to users in a wireless communication system.

Additional aspects will be set forth in part in the description which follows and, in part, will be apparent from the description, or may be learned by practice of the presented embodiments.

In accordance with an aspect of the disclosure, a method performed by a session management function (SMF) in a wireless communication system is provided. The method includes receiving, from a united data management (UDM), a list of user plane function (UPF) functionality components, selecting a UPF based on the list of UPF functionality components, and transmitting, to the selected UPF, a session establishment or modification request message.

The method performed by the SMF further includes receiving, from an access and mobility management function (AMF), a protocol data unit (PDU) session create request message including a requested list of user plane function (UPF) functionality components, wherein the selecting the UPF is performed further based on the requested list of UPF functionality components.

The session establishment is associated with a N4 session, and N4 session establishment or modification request message includes an activate list of UPF functionalities or a list of deactivate list of UPF functionalities.

The PDU session create request message includes information on mandatory or optional status for each UPF functionality in the requested list of UPF functionality components.

The N4 session establishment or modification request message includes indication of activation or deactivation of UPF functionalities.

The method further includes establishing, with a policy control function (PCF), a SM policy association, transmitting, to the PCF, a request message for default policy and charging control (PCC) rules including the list of UPF functionality components, and receiving, from the PCF, the PCC rules, wherein the PCC rule are determined based on the list of UPF functionality components.

In accordance with another aspect of the disclosure, a method performed by an access and mobility management function (AMF) in a wireless communication system is provided. The method includes receiving, from a user equipment (UE), a PDU session establishment request message including a requested list of user plane function (UPF) functionality components, selecting a session management function (SMF) based on a requested list of UPF functionality components and a list of supported UPF functionalities, transmitting, to the selected SMF, a packet data unit (PDU) session create request message including the requested list of UPF functionality components, and receiving, from the selected SMF, a PDU session create response message.

The PDU session create response message includes a PDU session rejection cause with information on at least one UPF functionality not allowed.

In accordance with another aspect of the disclosure, a session management function (SMF) in a wireless communication system is provided. The SMF includes a transceiver, and a controller configured to receive, from a united data management (UDM) a list of user plane function (UPF) functionality components, select a UPF based on the list of UPF functionality components, and transmit, to the selected UPF, a session establishment or modification request message.

In accordance with another aspect of the disclosure, an access and mobility management function (AMF) in a wireless communication system is provided. The AMF includes a transceiver, and a controller configured to receive, from a user equipment (UE), a protocol data unit (PDU) session establishment request message including a requested list of user plane function (UPF) functionality components, select a session management function (SMF) based on a requested list of UPF functionality components and a list of supported UPF functionalities, transmit, to the selected SMF, a packet data unit (PDU) session create request message including the requested list of UPF functionality components, and receive, from the selected SMF, a PDU session create response message.

The disclosed embodiment provides an apparatus and method that can effectively provide services to users by establishing a data session based on user services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a 5th generation (5G) network according to an embodiment of the disclosure;

FIG. 2 is a diagram illustrating user plane function (UPF) modules/functions according to an embodiment of the disclosure;

FIG. 3 illustrates an environment in which a heavy UPF and a light UPF are deployed and used according to an embodiment of the disclosure;

FIG. 4 illustrates a method for selecting a route for transmitting a service data flow created in a user equipment (UE) to a data network (DN) according to an embodiment of the disclosure;

FIG. 5 is a diagram illustrating a module that categorizes service data flow within a UE when the corresponding service data flow occurs and selects necessary UPF functions (Functionalities) according to an embodiment of the disclosure;

FIGS. 6A and 6B are diagrams illustrating a procedure for creating a packet data unit (PDU) session according to various embodiments of the disclosure;

FIG. 7 is a diagram illustrating a structure of a terminal according to an embodiment of the disclosure; and

FIG. 8 is a diagram illustrating a structure of a base station or network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known function and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some elements in the drawings are exaggerated, omitted, or schematically illustrated. Also, actual sizes of respective elements are not necessarily represented in the drawings. In the drawings, the same or corresponding elements are denoted by the same reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block(s). These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block(s).

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, elements such as software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements and a “unit”, or divided into a larger number of elements and a “unit”. Moreover, the elements and “units” or may be implemented to reproduce one or more central processing units (CPUs) within a device or a security multimedia card.

Hereinafter, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions. In addition, embodiments of the disclosure may also be applied to other communication systems having similar technical backgrounds or channel types as those of the embodiments of the disclosure described hereinafter. Also, embodiments of the disclosure are applicable to other communication systems through modification at the discretion of one of ordinary skill in the art without greatly departing from the scope of the disclosure.

In the following description, terms for identifying access nodes, terms referring to network entities or network functions (NF), terms referring to messages, terms referring to interfaces between network entities, terms referring to various identification information, and the like are used for convenience of description. Accordingly, the disclosure is not limited to terms to be described below, and other terms indicating objects having equal technical meanings may be used.

Hereinafter, for convenience of description, some of terms and names defined by the 3rd generation partnership project long term evolution (3GPP LTE) standard may be used. However, the disclosure is not limited to these terms and names, and may be equally applied to wireless communication systems conforming to other standards.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

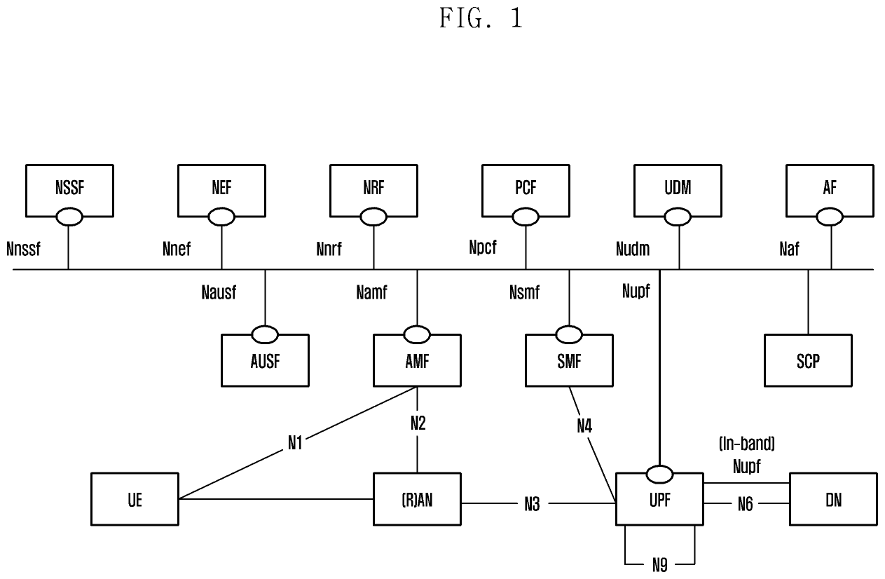

FIG. 1 illustrates a structure of a 5G network according to an embodiment of the disclosure.

Referring to FIG. 1, descriptions of network entities or network nodes constituting a 5G network are as follows.

An (radio) access network ((R)AN) is a subject that performs radio resource allocation of a terminal and may be an at least one of an eNode B, a node B, a base station (BS), a next generation radio access network (NG-RAN), a 5G-AN, a radio access unit, a base station controller, and a node on a network.

The terminal may include a user equipment (UE), a next generation UE (NG UE), a mobile station (MS), a cellular phone, a smart phone, a computer, or a multimedia system capable of performing a communication function. Hereinafter, although the embodiment of the disclosure is described by taking the 5G system as an example, the embodiment of the disclosure may be applied to other communication systems having a similar technical background. Further, the embodiments of the disclosure may be applied to other communication systems through some modifications within a range that does not significantly depart from the scope of the disclosure as determined by a person having skilled technical knowledge.

The wireless communication system defines a next generation (gen) core (NG core) or a 5G core network (5GC), which is a new core network as it evolves from a fourth generation (4G) system to a 5G system. The new core network virtualized all the existing network entities (NEs) and made it into a network function (NF). According to an embodiment of the disclosure, a network function (NF) may mean a network entity, a network component, and a network resource.

According to an embodiment of the disclosure, a 5GC may include NFs illustrated in FIG. 1. The 5GC is not limited to an example of FIG. 1 and may include a larger number of NFs or a smaller number of NFs than that illustrated in FIG. 1.

An access and mobility management function (AMF) may be a network function for managing the access and mobility of the user equipment (UE). As an example, the AMF may perform network functions such as registration, connection, reachability, mobility management, access identification, authentication, and mobility event generation.

A session management function (SMF) may be a network function for managing a packet data network (PDN) connection provided to the user equipment (UE). The PDN connection may be referred to as a packet data unit (PDU) session. For example, the SMF may perform functions, such as session establishment, correction, and dismissal, session management (SM) through maintenance of a tunnel between a UPF and a RAN, required for the session establishment, correction, and dismissal, UE's internet protocol (IP) address allocation and management, user plane selection and controlling, traffic processing controlling in the UPF, charge data collection controlling, or the like.

A policy control function (PCF) may be a network function that applies a service policy of a mobile communication operator to a terminal, a charging policy, and a policy for a PDU session.

A unified data management (UDM) may be a network function for storing information on a subscriber. The UDM may perform, for example, generation of authentication information for 3GPP security, user identifier (ID) processing, management of a list of network functions supporting a UE, subscription information management, or the like.

A network exposure function (NEF) may be a function of providing information on the terminal to a server outside the 5G network. Further, the NEF may provide a function of providing information necessary for providing a service to the 5G network and storing the information in a UDR.

A user plane function (UPF) may be a function that serves as a gateway for transferring user data (PDU) to a data network (DN). More particularly, the UPF may play a role in processing data so that data transmitted by the terminal may be delivered to an external network or data received from an external network may be delivered to the terminal. The UPF may perform, for example, network functions such as serving as an anchor between radio access technologies (RATs), packet routing and forwarding, packet inspection, user plane policy application, composition of a traffic use report, buffering, or the like.

A network repository function (NRF) may perform a function of discovering the NF.

An authentication server function (AUSF) may perform terminal authentication in a 3GPP access network and a non-3GPP access network.

A network slice selection function (NSSF) may perform a function of selecting a network slice instance provided to the terminal.

The data network (DN) may be a data network in which the terminal transmits and receives data in order to use a service of a network provider or a 3rd party service.

According to an embodiment of the disclosure, when the UPF includes several modules and functions (hereinafter referred to only as modules) according to the modular design, a method for configuring PDU session using the UPF in which a specific service data flow (Service Data Flow or IP Flow) includes specific modules is proposed.

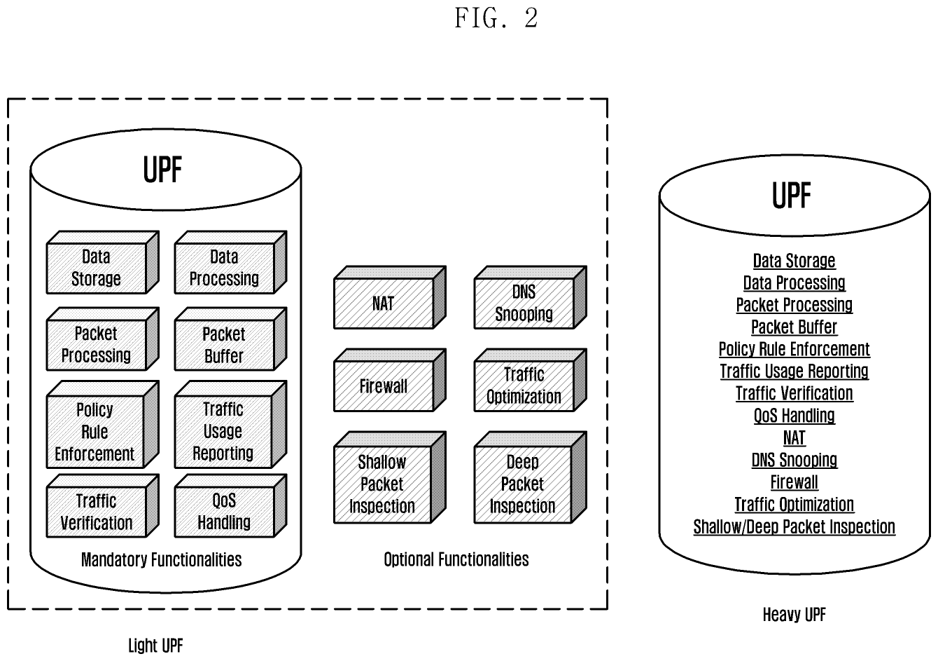

FIG. 2 is a diagram illustrating UPF modules/functions according to an embodiment of the disclosure.

Referring to FIG. 2, the services provided by the UPF are classified as a mandatory functionality and an optional functionality. The mandatory functionalities are functions required for the services provided by the UPF defined in the standard, and the optional functionalities are functions required to provide additional services in addition to the UPF functions defined in the standard. For example, the UPF must necessarily include the functions of receiving user packets from the DN and transmitting the received user packets to the UE, and receiving user packets from the UE and transmitting the received user packets to the DN. For this, the UPF needs a packet processing module. However, the service/function for the shallow/deep packet inspection operation to inspect user packets received from the UE or DN may not be the service/function that the UPF defined in the standard must provide.

If the UPF is modularized by function, resources for each module may be expanded/contracted, so the flexibility of resource provision through the UPF may be expanded. In addition, since the optional functionalities that are not the mandatory functionalities may be added to or deleted from the UPF at any time as needed, a modularized UPF may be provided at a relatively lower price than a UPF that has all the mandatory functionalities and optional functionalities as before.

In this specification, the UPF in which all functions are modularized according to module design and includes only mandatory functionalities, excluding optional functionalities, may be referred to as a light UPF. In addition, like the UPF on the right side in FIG. 2, the UPF that includes both mandatory and optional functionalities without modularizing its functions may be referred to as a heavy UPF.

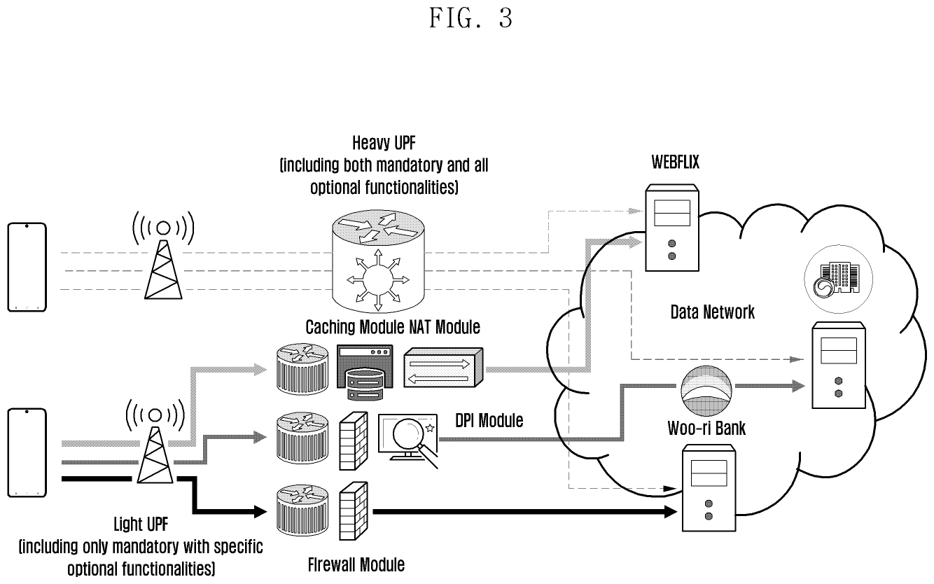

FIG. 3 illustrates an environment in which a heavy UPF and light UPF are deployed and used according to an embodiment of the disclosure.

Referring to FIG. 3, in an environment where the existing Heavy UPF is used, the UE may transmit and receive data with the DN using the same UPF regardless of the service flow used by the UE. However, in an environment where the light UPF is used, the UE may select the light UPF that provides different optional functionalities depending on the requirements of the UE service flow. For example, because security is important in the case of service flow for banking services, the UE may communicate data with the DN using the light UPF, which provides a firewall function, and in the case of service flow for video streaming services, the UE may communicate data with the DN using the light UPF, which provides a caching function that may reduce transmission delay.

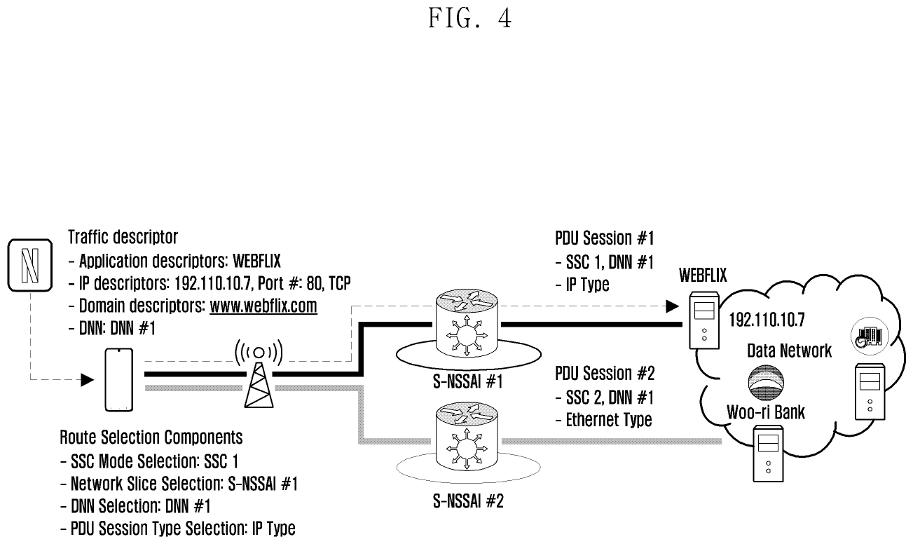

FIG. 4 illustrates a method for selecting a route for transmitting a service data flow created in the UE to the DN according to an embodiment of the disclosure.

Referring to FIG. 4, in a 5G network, UE route selection policy (URSP) information is used to select a route to transmit the service data flow created in the UE to the DN. The URSP information includes a list of prioritized URSP rules. In addition, each URSP rule includes rule precedence for application priority, a traffic descriptor for distinguishing service data flows, and a list of route selection descriptions for selecting a route of service data flow divided by the traffic descriptor.

The traffic descriptor may be constituted to include the following information: application descriptors, IP descriptors, domain descriptors, non-IP descriptors, data network name (DNN). Each route selection descriptor includes route selection descriptor precedence and route selection components for the priority of the application of each route selection descriptor, and route selection validation criteria. The route selection components may be constituted to include the following information: session and service continuity (SSC) mode selection, network slice selection, DNN selection, PDU session type selection, access type preference.

Tables 1 to 3 below are tables related to UE route selection policy information extracted from 3GPP standard document TS 23.503.

TABLE 1
UE Route Selection Policy

| | | | PCF | |
|---|---|---|---|---|
| | | | permitted to | |
| Information | | | modify in a | |
| name | Description | Category | URSP | Scope |
| URSP | 1 or more URSP rules | Mandatory | Yes | UE |
| rules | as specified in table 2. | | | context |

TABLE 2
UE Route Selection Policy Rule

| | | | PCF | |
|---|---|---|---|---|
| | | | permitted to | |
| Information | | | modify in a | |
| name | Description | Category | UE context | Scope |
| Rule | Determines the order | Mandatory | Yes | UE |
| Precedence | the URSP rule is | (NOTE 1) | | context |
| | enforced in the UE. | | | |
| Traffic | This part defines the | Mandatory | | |
| descriptor | Traffic descriptor | (NOTE 3) | | |
| | components for the | | | |
| | URSP rule. | | | |
| Application | It consists of OSId and | Optional | Yes | UE |
| descriptors | OSAppId(s) (NOTE 2, | | | context |
| | NOTE 8). | | | |
| IP | Destination IP 3 | Optional | Yes | UE |
| descriptors | tuple(s) (IP address or | | | context |
| (NOTE 6) | IPv6 network prefix, | | | |
| | port number, protocol | | | |
| | ID of the protocol | | | |
| | above IP) (NOTE 8). | | | |
| Domain | FQDN(s) or a regular | Optional | Yes | UE |
| descriptors | expression which are | | | context |
| | used as a domain name | | | |
| | matching criteria | | | |
| | (NOTE 7, NOTE 8). | | | |
| Non-IP | Descriptor(s) for | Optional | Yes | UE |
| descriptors | destination | | | context |
| (NOTE 6) | information of non-IP | | | |
| | traffic (NOTE 8). | | | |
| DNN | This is matched | Optional | Yes | UE |
| | against the DNN | | | context |
| | information provided | | | |
| | by the application | | | |
| | (NOTE 8). | | | |
| Connection | This is matched | Optional | Yes | UE |
| Capabilities | against the information | | | context |
| | provided by a UE | | | |
| | application when it | | | |
| | requests a network | | | |
| | connection with | | | |
| | certain capabilities | | | |
| | (NOTE 4, NOTE 8) or | | | |
| | traffic categories | | | |
| | (NOTE 5). | | | |
| PIN ID | Matched against a PIN | Optional | Yes | UE |
| | ID for a specific PIN | | | context |
| | configured in the | | | |
| | PEGC (NOTE 9). | | | |
| List of | A list of Route | Mandatory | | |
| Route | Selection Descriptors. | | | |
| Selection | The components of a | | | |
| Descriptors | Route Selection | | | |
| | Descriptor are | | | |
| | described in table 3. | | | |

TABLE 3
Route Selection Descriptor

| | | | PCF | |
|---|---|---|---|---|
| | | | permitted to | |
| Information | | | modify in | |
| name | Description | Category | URSP | Scope |
| Route | Determines the order | Mandatory | Yes | UE |
| Selection | in which the Route | (NOTE 1) | | context |
| Descriptor | Selection Descriptors | | | |
| Precedence | are to be applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value or | Optional | Yes | UE |
| Slice | a list of values of | (NOTE 3) | | context |
| Selection | single network slice | | | |
| | selection assistance | | | |
| | information(s) (S- | | | |
| | NSSAI(s)). | | | |
| DNN | Either a single value or | Optional | Yes | UE |
| Selection | a list of values of | | | context |
| | DNN(s). | | | |
| PDU | One single value of | Conditional | Yes | UE |
| Session | PDU Session Type | (NOTE 8) | | context |
| Type | | | | |
| Selection | | | | |
| Non- | Indicates if the traffic | Optional | Yes | UE |
| Seamless | of the matching | (NOTE 4) | | context |
| Offload | application is to be | | | |
| indication | offloaded to non-3GPP | | | |
| | access outside of a | | | |
| | PDU Session. | | | |
| ProSe | Indicates if the traffic | Optional | Yes | UE |
| Layer-3 | of the matching | (NOTE 4) | | context |
| UE-to- | application is to be | | | |
| Network | sent via a ProSe Layer- | | | |
| Relay | 3 UE-to-Network | | | |
| Offload | Relay outside of a | | | |
| indication | PDU session. | | | |
| ProSe | Indicates if the traffic | Optional | Yes | UE |
| Multi-path | of the matching | (NOTE 9) | | context |
| Preference | application is preferred | | | |
| | to be sent via a PDU | | | |
| | Session over the Uu | | | |
| | reference point and a | | | |
| | ProSe Layer-3 UE-to- | | | |
| | Network Relay outside | | | |
| | of a PDU session. | | | |
| Access | Indicates the preferred | Optional | Yes | UE |
| Type | Access Type (3GPP or | | | context |
| preference | non-3GPP or Multi- | | | |
| | Access) when the UE | | | |
| | establishes a PDU | | | |
| | Session for the | | | |
| | matching application. | | | |
| PDU | An indication shared | Optional | Yes | UE |
| Session Pair | by redundant PDU | | | context |
| ID | Sessions as described | | | |
| | in clause 5.33.2.1 of | | | |
| | TS 23.501 [2]. | | | |
| RSN | The RSN as described | Optional | Yes | UE |
| | in clause 5.33.2.1 of | | | context |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. The | | | |
| | RSD is not considered | | | |
| | to be valid if the | | | |
| | current time is not in | | | |
| | the time window. | | | |
| Location | The UE location where | Optional | Yes | UE |
| Criteria | the matching traffic is | | | context |
| | allowed. The RSD rule | | | |
| | is not considered to be | | | |
| | valid if the UE | | | |
| | location does not | | | |
| | match the location | | | |
| | criteria. | | | |

Referring to FIG. 4, the service data flow created in the UE may be classified by a traffic descriptor and a route may be selected by the corresponding route selection components. In this process, the route selection may mean selection of a PDU session. For example, if there is a PDU session that satisfies the values of the route selection components among the existing PDU sessions created by the UE, the newly created service data flow is transmitted to the DN using that PDU session. If there is no PDU session that satisfies the values of the route selection components among the previously created PDU sessions, a new PDU session is created using the route selection components value and the service data flow is transmitted to the DN using the PDU session.

In the example in FIG. 4, the values of route selection components are as follows.
SSC mode selection: SSC 1
Network slice selection: S-NSSAI #1
DNN selection: DNN #1
PDU session type selection: IP Type

Since PDU session #1 among existing PDU sessions satisfies this, PDU session #1 is selected as a route for the newly created service data flow, and data may be transmitted to the DN through the selected route.

In the disclosure, in an environment where a light UPF with a modular design is deployed, that is, in an environment where UPFs with different services provided are mixed, in case that a new service data flow is created and the service data flow cannot be transmitted to the DN using the existing PDU session, a method for creating a PDU session considering the presence or absence of a light UPF when creating a new PDU session for transmitting the service data flow is proposed. In addition, a method for handling a PDU session in a mobile communication network with a mixture of light UPF and heavy UPF is proposed.

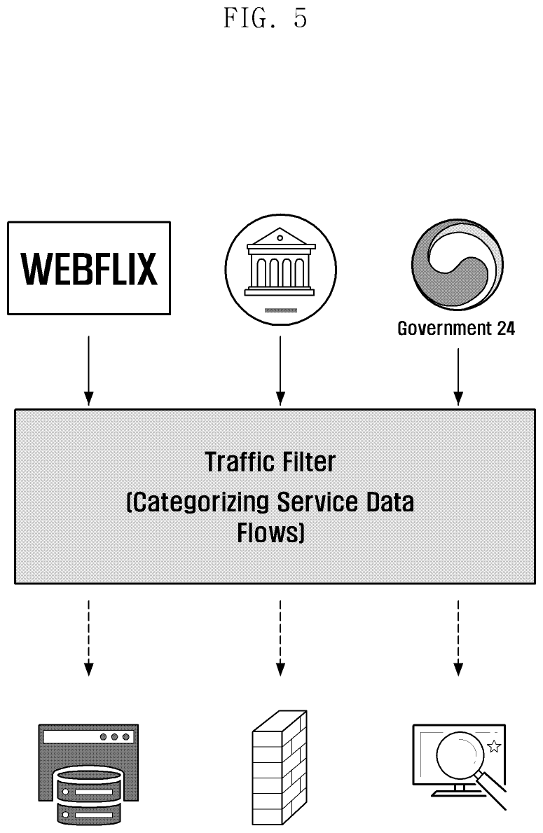

FIG. 5 is a diagram illustrating a module that categorizes the corresponding service data flow within the UE when a service data flow occurs and selects necessary UPF functionalities according to an embodiment of the disclosure.

Referring to FIG. 5, when a new service data flow occurs, appropriate UPF functionalities are selected for the corresponding flows based on the server IP address, port number, and protocol (e.g., transmission control protocol (TCP), user datagram protocol (UDP), or the like) of the corresponding service data flow. For example, because security is important for service data flows created in banking applications, a firewall function may be selected.

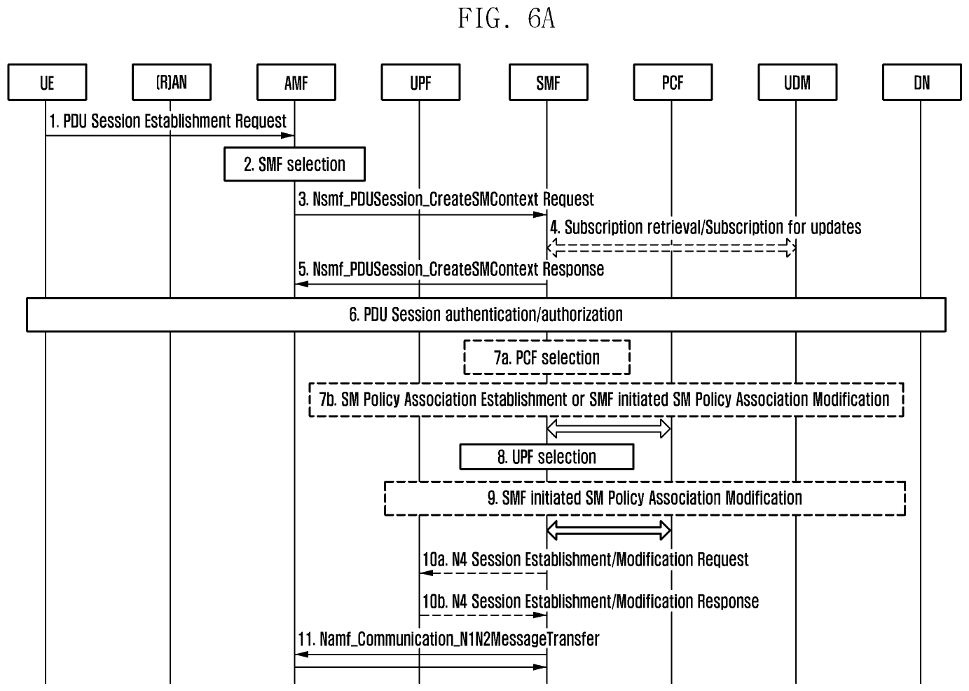

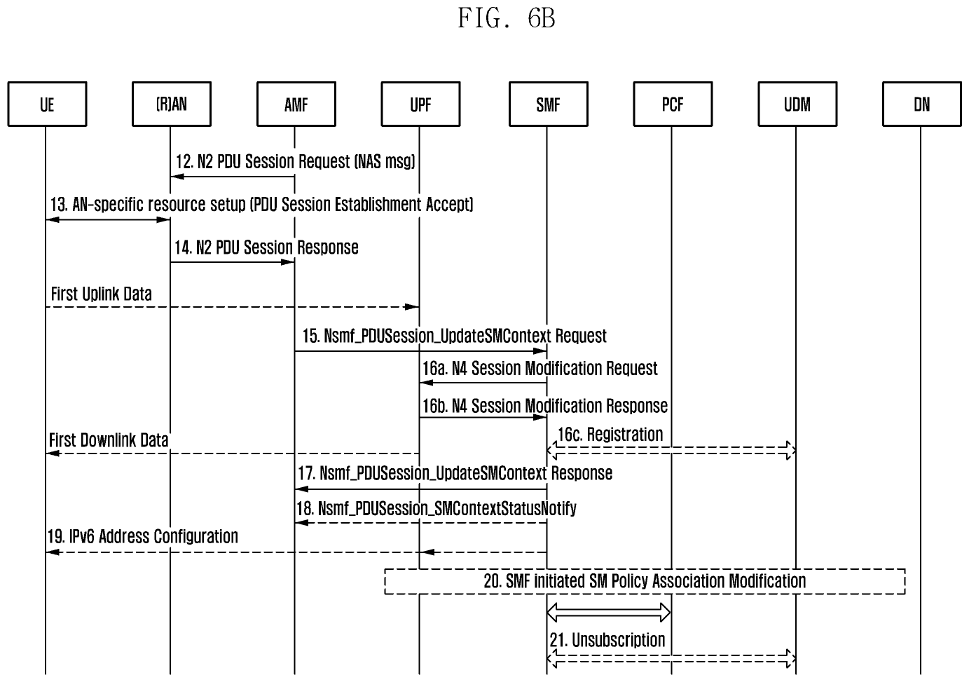

FIGS. 6A and 6B are diagrams illustrating a procedure for creating a PDU session according to various embodiments of the disclosure.

Referring to FIGS. 6A and 6B, a PDU session creation procedure considering when the light UPF proposed by the disclosure is deployed will be described. Operations not described in the procedure below may operate in the manner disclosed in 3GPP TS 23.502.

When a new service data flow occurs in operation 1, if a suitable PDU session to transmit this flow has not been created, the UE performs a new PDU session creation procedure. For this purpose, a PDU session establishment request message is transmitted to a network. This message may include the following information: PDU session ID, requested PDU session type, requested SSC mode, 5G session management (5GSM) capability, protocol configuration option (PCO), SM PDU DN request container, number of packet filters, header compression configuration, UE integrity protection maximum data rate, always-on PDU session Requested, redundancy sequence number (RSN), connection capabilities, and PDU session pair ID. This message may additionally include the following information for UPF functionalities: requested list of UPF functionality components [UPF Functionality (e.g., network address translation (NAT), domain name system (DNS) snooping, firewall, traffic optimization, shallow packet inspection), or deep packet inspection, or the like), mandatory or optional]. Additional information included may be determined by the traffic filter module or URSP within the UE.

Each UPF functionality component must include a UPF functionality and mandatory or optional. The UPF functionality indicates the UPF functionality that the light UPF serving the created PDU session must include. The mandatory or optional indicates whether the UPF functionality is a mandatory functionality or an optional functionality. In other words, in case that it is the mandatory functionality, the corresponding functionality must be provided by the light UPF, and in case that it is the optional functionality, the corresponding functionality may not be provided in some cases. The UE generates as many UPF functionality components as the type of UPF functionality required and includes the UPF functionality components in the PDU session establishment request message in the form of a requested list of UPF functionality components to be transmitted to the network. As an example, the list of UPF functionality components included in the PDU session establishment request message may have the following form [(firewall, required), (caching, optional)].

In operation 2, the AMF receives the PDU session establishment request message and selects an appropriate SMF. The AMF may consider the following information to select the SMF: DNN, S-NSSAI, access technology, support for CP cellular internet of things (CIOT) 5G system (5GS) optimization, subscription information from UDM, local operator policies, SFM's load conditions (load conditions of candidate SMFs), UE location, service area of SMFs, target data network access identifier (DNAI), or the like. The AMF may additionally consider the following information during the SMF selection process: list of supported UPF functionalities.

In operation 3, the AMF transmits the Nsmf_PDUSession_CreateSMContext request message to the selected SMF. This message may include the following information: subscription permanent identifier (SUPI), selected DNN, UE requested DNN, S-NSSAI(s), PDU session ID, AMF ID, request type, [PCF ID, same PCF selection indication], priority access, small data rate control status, N1 SM container (PDU session establishment request), user location information, access type, radio access technology (RAT) type, permanent equipment identifier (PEI), generic public subscription identifier (GPSI), UE presence in LADN service area, subscription for PDU session status notification, DNN selection mode, trace requirements, control plane CIOT 5GS optimization indication, control plane only indicator, satellite backhaul category, geostationary earth orbit (GEO) satellite ID, [public/private virtual server fully qualified domain name(s) (PVS FQDN(s)) and/or PVS IP address(es), onboarding indication], disaster roaming service indication. This message may additionally include the following information for the UPF functionality: requested list of UPF functionality components [UPF functionality (e.g., NAT, DNS snooping, firewall, traffic optimization, shallow packet inspection, or deep packet inspection, or the like), mandatory or optional].

In operation 4, the SMF transmits a Nudm_SDM_Get message to the UDM to request the UE's session management subscription data. This message may include the following information: SUPI, session management subscription data, selected DNN, S-NSSAI of home public land mobile network (HPLMN), serving public land mobile network (PLMN) ID, network identifier (NID). The session management subscription data received by the SMF from the UDM may additionally include the following information: allowed UPF functionalities of UE. The allowed UPF Functionalities information includes information about UPF functionality that the user may use in the corresponding mobile communication network.

If the UPF functionality included in the requested list of UPF functionality components is not included in the allowed UPF Functionalities received from the UDM, the UE's PDU session creation request may be rejected. If the corresponding UPF functionality is the optional functionality, it may be ignored and the PDU session creation request may be performed. However, if the corresponding UPF functionality is the mandatory functionality, the PDU session creation request may be rejected or accepted depending on the network policy.

In operation 5, the SMF transmits the Nsmf_PDUSession_CreateSMContext response message to the AMF. This message may include the following information: cause, SM context ID or N1 SM container (PDU session rejection cause). In addition, the PDU session rejection cause value may include information about PDU session rejection: cause (requested UPF functionalities is/are not allowed). In operation 6, it entails PDU session authentication/authorization.

In operations 7a/b, the SMF may select a PCF and establish an SM policy association. The SMF may consider the following information to select a PCF for the PDU session it creates: local operator policies, DNN, S-NSSAI, SUPI, PCF selected for UE, PCF group ID provided by AMF (PCF Set ID), same PCF selection indication. The SMF may additionally consider the following information for PCF selection: list of supported UPF functionalities. The SMF allows SM policy association to be associated with PCF and requests default PCC rules for the PDU session. This PCC rule may be determined based on the list of supported UPF functionalities.

In operation 8, the SMF selects the UPF that will serve the PDU session it creates. The SMF may consider the following information to select the UPF; UPF's dynamic load, UPF location available at SMF, DNN, PDU session type, SSC mode, UE subscription profile, DNAI, S-NSSAI, access technology, information related to user plane topology, support for UPF allocation of IP address/prefix, support for high latency communication. The SMF may additionally consider the following information for UPF functionality; list supported of UPF functionality components [UPF functionality (e.g., NAT, DNS snooping, firewall, traffic optimization, shallow packet inspection, or deep packet inspection, or the like), mandatory or optional]. In operation 9, it entails SMF initiated SM Policy Association Modification.

In operations 10a/b, establishment and modification of the N4 session may be performed between the SMF and the selected UPF. For this purpose, the SMF may transmit the following information to the UPF: packet detection, enforcement and reporting rules. The information transmitted from the SMF to the UPF may additionally include the following information for the UPF functionality: list of supported UPF functionality components [UPF functionality (e.g., NAT, DNS snooping, firewall, traffic optimization, shallow packet inspection, or deep packet inspection, or the like), Mandatory or Optional], indication of activation or deactivation of UPF functionalities [activate list of UPF functionalities, deactivated UPF functionality that UPF provides but is not included in the list supported of UPF functionalities (Deactivate UPF Functionalities, which UPF provides UPF functionalities, not in List Supported of UPF Functionalities)]. Among the functionalities that the UPF may provide, the indication of activation or deactivation of UPF functionalities may refers to a functionality that is currently activated and provides a service to a service data flow, or a functionality that is currently deactivated and does not provide a service to a service data flow. The deactivated UPF functionalities are the functionalities that have not been selected for the new service data flow among the functionalities that UPF may provide.

In operation 11, the SMF transmits the Namf_Communication_N1N2MessageTransfer message to the AMF. This message may contain the following information: PDU session ID, N2 SM information (PDU session ID, QFI(s), QoS profile(s), CN tunnel Info, S-NSSAI from the allowed NSSAI, session-AMBR, PDU session type, user plane security enforcement information, UE integrity protection maximum data rate, RSN, PDU session pair ID, TL-container), N1 SM container (Accept/reject PDU session establishment). In operation 12, the AMF transmits N2 PDU Session Request (NAS msg) to the (R) AN. In operation 13, it entails AN-specific resource setup (PDU Session Establishment Account). In operation 14, the (R)AN transmits PDU session Response to the AMF.

The N1 SM container (PDU session establishment acceptance) message included in this message may include the following information; [QoS rule(s) and QoS flow level QoS parameters if needed for the QoS flow(s) associated with the QoS rule(s)], selected SSC mode, S-NSSAI(s), UE requested DNN, allocated IPv4 address, interface identifier, session-AMBR, selected PDU session type, [reflective QoS timer] (if available), [P-CSCF address(es)], [control plane only indicator], [header compression configuration], [always-on PDU session granted], [small data rate control parameters], [small data rate control status], [serving PLMN rate control], [PVS FQDN(s) and/or PVS IP address(es)]). In addition, the Namf_Communication_N1N2MessageTransfer message transmitted from the SMF to the AMF may further include the following information for UPF functionalities: selected UPF functionalities from the allowed UPF functionalities (e.g., NAT, DNS snooping, firewall, traffic optimization, shallow packet inspection, or deep packet inspection, or the like), grant indication for requested UPF functionalities if allow requested UPF functionalities which is not in allowed UPF functionalities). The selected UPF functionalities may be the UPF functionalities that are included in the allowed UPF functionalities of the UE's requested UPF functionalities and are determined to be provided to the UE by the SMF. The grant indication for the requested UPF functionalities may indicate whether the UPF functionalities are allowed, wherein the UPF functionalities are the UPF functionalities that are not included in the allowed UPF functionalities of the UE's requested UPF functionalities and are determined to be provided to the UE by the SMF.

The N1 SM container (PDU session establishment refusal) message included in this message may include the following information: PDU session rejected: cause (requested UPF functionalities are not allowed).

In operation 15, the AMF transmits the Nsmf_PDUSession_UpdateSMContext Request message to the SMF. This message may include the following information: SM context ID, N2 SM information, request type. In addition, if the configuration of user plane (UP) resources fails due to a problem with N2 SM information supporting UPF functionalities, the SMF includes a PDU session establishment rejection message in the N1 SM container in the Nsmf_PDUSession_UpdateSMContext Response message in operation 17 and must notify of the UE that the PDU session creation request has been rejected in operation 18.

In operation 16a/b, the SMF and UPF exchange N4 session modification request/response messages. If a specific UPF functionality is not supported due to UP resource issues, the corresponding UPF functionality is deactivated. If PDU session configuration is rejected, the N4 session for the corresponding PDU session may also be released.

In operation 16c, the SMF registers the corresponding PDU session-related information with the UDM using the Nudm_UECM_Registration message. This message may include the following information: SUPI, DNN, S-NSSAI of HPLMN, PDU session ID, SMF Identity, serving node PLMN ID, [NID]. In addition, the Nudm_UECM_Registration message may further include the following information for the UPF functionality: selected UPF functionalities. The selected UPF functionality includes UPF function information provided by the network for the corresponding PDU session.

Tables 4 and 5 below show information added to UDM related to UPF functionalities.

TABLE 4
Session Management Subscription Data

| Session | GPSI List | List of the GPSI (Generic Public |
|---|---|---|
| Management | | Subscription Identifier) used both |
| Subscription | | inside and outside of the 3GPP system |
| data (data | | to address a 3GPP subscription. |
| needed for PDU | | |
| Session | Internal Group ID-list | List of the subscribed internal |
| Establishment) | | group(s) that the UE belongs to. |
| | Trace Requirements | Trace requirements about a UE (e.g., |
| | | trace reference, address of the Trace |
| | | Collection Entity, or the like . . . ) is |
| | | defined in TS 32.421 [39]. |
| | | This information is only sent to a |
| | | SMF in the HPLMN or one of its |
| | | equivalent PLMN(s). |
| | Routing Indicator | Routing Indicator assigned to the |
| | | SUPI. |
| | Session Management Subscription data contains one or more S- | |
| | NSSAI level subscription data: | |
| | S-NSSAI | Indicates the value of the S-NSSAI. |
| | Subscribed DNN list | List of the subscribed DNNs for the |
| | | S-NSSAI (NOTE 1). |
| | For each DNN in S-NSSAI level subscription data: | |
| | DNN | DNN for the PDU Session. |
| | Aerial service indication | Indicates whether the DNN is used for |
| | | aerial services (e.g., UAS operations |
| | | or C2, or the like) as described in |
| | | TS 23.256 [80]. |
| | Framed Route | Set of Framed Routes. A Framed |
| | information | Route refers to a range of IPv4 |
| | | addresses / IPv6 Prefixes to associate |
| | | with a PDU Session established on |
| | | this (DNN, S-NSSAI). |
| | | See NOTE 4. |
| | IP Index information | Information used for selecting how |
| | | the UE IP address is to be allocated |
| | | (see clause 5.8.2.2.1 in |
| | | TS 23.501 [2]). |
| | Allowed PDU Session | Indicates the allowed PDU Session |
| | Types | Types (IPv4, IPv6, IPv4v6, Ethernet |
| | | and Unstructured) for the DNN, S- |
| | | NSSAI. See NOTE 6. |
| | Default PDU Session | Indicates the default PDU Session |
| | Type | Type for the DNN, S-NSSAI. |
| | Allowed SSC modes | Indicates the allowed SSC modes for |
| | | the DNN, S-NSSAI. |
| | Allowed UPF | Indicates the allowed UPF |
| | Functionalities | Functionalities for the DNN, S- |
| | | NSSAI. |
| | Default SSC mode | Indicate the default SSC mode for the |
| | | DNN, S-NSSAI. |
| | Interworking with EPS | Indicates whether interworking with |
| | indication | EPS is supported for this DNN and S- |
| | | NSSAI. |
| | 5GS Subscribed QoS | The QoS Flow level QoS parameter |
| | profile | values (5QI and ARP) for the DNN, |
| | | S-NSSAI (see clause 5.7.2.7 of |
| | | TS 23.501 [2]). |
| | Charging Characteristics | It contains Charging Characteristics |
| | | as defined in Annex A clause A.1 of |
| | | TS 32.255 [45]. This information, |
| | | when provided, shall override any |
| | | corresponding predefined information |
| | | at the SMF. |
| | Subscribed-Session- | The maximum aggregated uplink and |
| | AMBR | downlink MBRs to be shared across |
| | | all Non-GBR QoS Flows in each |
| | | PDU Session, which are established |
| | | for the DNN, S-NSSAI. |
| | Static IP address/prefix | Indicate the static IP address/prefix |
| | | for the DNN, S-NSSAI. |
| | User Plane Security | Indicates the security policy for |
| | Policy | integrity protection and encryption for |
| | | the user plane. |
| | PDU Session continuity | Provides for this DDN, S-NSSAI how |
| | at inter RAT mobility | to handle a PDU Session when UE the |
| | | moves to or from NB-IoT. Possible |
| | | values are: maintain the PDU session; |
| | | disconnect the PDU session with a |
| | | reactivation request; disconnect PDU |
| | | session without reactivation request; |
| | | or to leave it to local VPLMN policy. |
| | NEF Identity for NIDD | When present, indicates, per S-NSSAI |
| | | and per DNN, the identity of the NEF |
| | | to anchor Unstructured PDU Session. |
| | | When not present for the S-NSSAI |
| | | and DNN, the PDU session terminates |
| | | in UPF (see NOTE 8). |
| | NIDD information | Information such as External Group |
| | | Identifier, External Identifier, |
| | | MSISDN, or AF Identifier used for |
| | | SMF-NEF Connection. |
| | SMF-Associated | Parameters on expected |
| | Expected UE Behaviour | characteristics of a PDU Session their |
| | parameters | corresponding validity times as |
| | | specified in clause 4.15.6.3. |
| | Suggested number of | Parameters on expected PDU session |
| | downlink packets | characteristics as specified in clauses |
| | | 4.15.3.2.3b and 4.15.6.3a. |
| | ATSSS information | Indicates whether MA PDU session |
| | | establishment is allowed. |
| | Secondary | Indicates that whether the Secondary |
| | authentication indication | authentication/authorization (as |
| | | defined in clause 5.6 of |
| | | TS 23.501 [2]) is required for PDU |
| | | Session Establishment or PDN |
| | | Connection Establishment as |
| | | specified in clause 4.3.2.3 and |
| | | clause H.2. (see NOTE 14) |
| | DN-AAA Server UE IP | Indicates that whether the SMF is |
| | address allocation | required to request the UE IP address |
| | indication | from the DN-AAA Server (as defined |
| | | in clause 5.6 of TS 23.501 [2]) for |
| | | PDU Session Establishment or or |
| | | PDN Connection Establishment as |
| | | specified in clause 4.3.2.3 and |
| | | clause H.2. |
| | DN-AAA Server | If at least one of secondary DN-AAA |
| | addressing information | authentication, DN-AAA |
| | | authorization or DN-AAA UE IP |
| | | address allocation is required by |
| | | subscription data, the subscription |
| | | data may also contain DN-AAA |
| | | Server addressing information. |
| | Edge Configuration | Consists of one or more ECS |
| | Server Address | Configuration Information as defined |
| | Configuration | in clause 8.3.2.1 of TS 23.558 [83]. |
| | Information | The ECS Configuration Information |
| | | sent by UDM to SMF is associated |
| | | with the PLMN ID where the UE is |
| | | roaming on. (see NOTE 20) |
| | API based secondary | Indicates that whether the API based |
| | authentication indication | Secondary |
| | | authentication/authorization (as |
| | | defined in clause 5.2.3 of |
| | | TS 23.256 [80]) is required for PDU |
| | | Session Establishment or PDN |
| | | Connection Establishment as |
| | | specified in clause 4.3.2.3 and |
| | | clause H.2 (see NOTE 14). |
| | UE authorization for | Indicates whether the UE is |
| | EAS discovery via | authorized to use 5GC assisted EAS |
| | EASDF | discovery via EASDF (as defined in |
| | | TS 23.548 [74]). |
| | HR-SBO authorization | Indicates whether the VPLMN is |
| | indication | authorized for Home Routed Session |
| | | Breakout (HR-SBO) (see NOTE 17 |
| | | and NOTE 18). |

TABLE 5
UE context in SMF data

| UE context in | SUPI | Key. |
|---|---|---|
| SMF | PDU Session Id(s) | List of PDU Session Id(s) for the UE. |
| data | For emergency PDU Session Id: | |
| | Emergency Information | The SMF + PGW-C FQDN for |
| | | emergency session used for |
| | | interworking with EPC. |
| | For each non-emergency PDU Session Id: | |
| | DNN | DNN for the PDU Session. |
| | SMF | Allocated SMF for the PDU Session. |
| | | Includes SMF IP Address and SMF |
| | | NF Id. |
| | SMF + PGW-C FQDN | The S5/S8 SMF + PGW-C FQDN used |
| | | for interworking with EPS (see |
| | | NOTE 5). |
| | PCF ID | The PCF ID serving the PDU |
| | | Session/PDN Connection. |
| | Selected UPF | UPF Functionalities for the PDU |
| | Functionalities | Session |

In a mobile communication network where modularized UPF and existing UPF are mixed, the UE and network may operate as follows.

When the UE registers with a mobile communication network, the following may be identified using the UE core network capability with the network; modularized UPF only deployment (if available), normal UPF only deployment (if available), both modularized UPF and normal UPF deployment) (if available).

Alternatively, if the values for UPF functionalities are included in the PDU session establishment request message and transmitted in a mobile communication network where modularized UPF is not deployed or is mixed with existing UPF, the following operation may be performed.

In case that the mobile communication network has information about the user's allowed UPF functionalities in the UDM, the mobile communication network rejects the PDU session establishment request or grants all requested UPF functionalities.

In case that the mobile communication network does not have information about the allowed UPF functionalities for the user in the UDM, the mobile communication network may perform the PDU session establishment procedure without considering the requested UPF functionalities.

In case that the values of the requested UPF functionalities are included in the PDU session establishment request message in a network where modularized UPF and existing UPF are mixed among mobile communication networks, the method proposed in the disclosure may be operated. In case that the values of the requested UPF functionalities are not included in the corresponding message, the existing PDU session configuration method may be used. In operation 19, the SMF transmits IPv6 Address Configuration to the UE. In operation 20, it entails SMF initiated SM Policy Association Modification. In operation 21, it entails unsubscription between SMF and UDM.

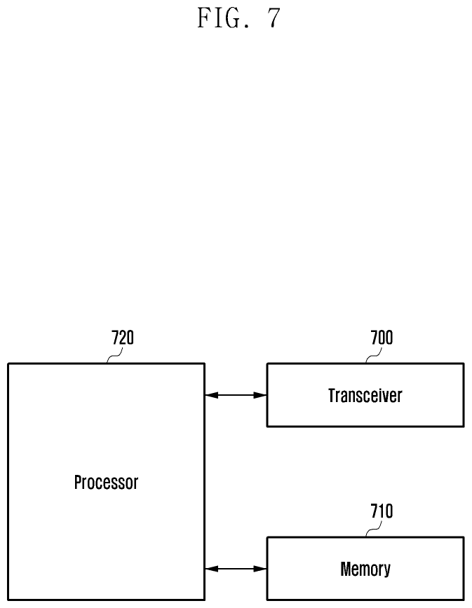

FIG. 7 is a diagram illustrating a structure of the terminal according to an embodiment of the disclosure.

Referring to FIG. 7, the terminal according to an embodiment of the disclosure may include a processor 720 configured to control overall operations of the terminal, a transceiver 700 including a transmitter and a receiver, and memory 710. However, the UE is not limited to the above example, and may include a greater number of or fewer components than those illustrated in FIG. 7.

According to an embodiment of the disclosure, the transceiver 700 may transmit or receive a signal to or from network entities or other terminals. A signal transmitted to or from a network entity may include control information and data. In addition, the transceiver 700 may receive a signal via a radio channel and output the same to the processor 720, and transmit the signal output from the processor 720, via the radio channel.

According to an embodiment of the disclosure, the processor 720 may control the terminal such that the terminal performs any one operation of the above-described embodiments. The processor 720, memory 710, and transceiver 700 are not necessarily implemented as separate modules but may also be implemented as a single component, for example, in the form of a single chip. Also, the processor 720 and transceiver 700 may be electrically connected to each other. Also, the processor 720 may be an application processor (AP), a communication processor (CP), a circuit, an application-specific circuit, or at least one processor.

According to an embodiment of the disclosure, the memory 710 may store data such as a basic program for operation of the terminal, an application program, configuration information, or the like. More particularly, the memory 710 provides stored data according to a request from the processor 720. The memory 710 may be constituted in a storage medium, such as read-only memory (ROM), random access memory (RAM), a hard disk, compact disc-ROM (CD-ROM), or a digital versatile disc (DVD), or a combination thereof. In addition, the memory 710 may be included by a plural number. In addition, the processor 720 may execute the above-described embodiments based on a program stored in the memory 710, the program being designed to perform the above-described embodiments of the disclosure.

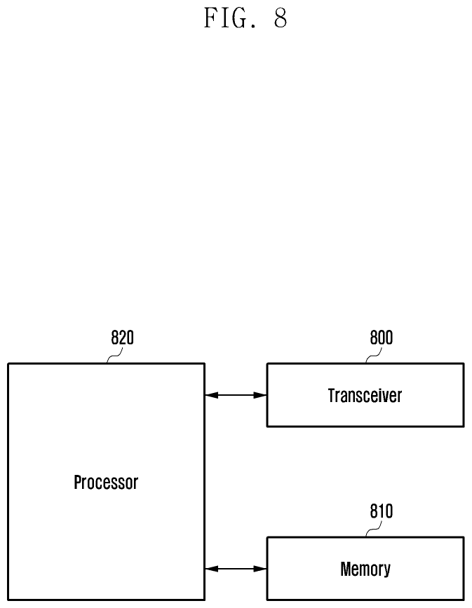

FIG. 8 is a diagram illustrating a structure of a base station or network entity according to an embodiment of the disclosure.

Referring to FIG. 8, the network entity according to an embodiment of the disclosure may include a processor 820 configured to control overall operations of the network entity, a transceiver 800 including a transmitter and a receiver, and memory 810. However, the network entity is not limited to the above example, and may include a greater number of or fewer components than those illustrated in FIG. 8.

According to an embodiment of the disclosure, the transceiver 800 may transmit or receive a signal to or from other network entities or at least one of terminals. The signal transmitted or received to or from the other network entities or at least one of the terminals may include control information and data.

According to an embodiment of the disclosure, the processor 820 may control the network entity such that the network entity performs any one operation of the above-described embodiments. Meanwhile, the processor 820, memory 810, and transceiver 800 are not necessarily implemented as separate modules but may also be implemented as a single component, for example, in the form of a single chip. In addition, the processor 820 and transceiver 800 may be electrically connected to each other. Also, the processor 820 may be an application processor (AP), a communication processor (CP), a circuit, an application-specific circuit, or at least one processor.

According to an embodiment of the disclosure, the memory 810 may store data such as a basic program for operation of the network entity, an application program, configuration information, or the like. In particular, the memory 810 provides stored data according to a request from the processor 820. The memory 810 may be configured in a storage medium, such as ROM, RAM, a hard disk, CD-ROM, or DVD, or a combination thereof. The memory 810 may be included by a plural number. Also, the processor 820 may execute the above-described embodiments based on a program stored in the memory 810, the program being designed to perform the above-described embodiments of the disclosure.

The above-described structural diagram, a diagram of a method of transmitting a control/data signal, a diagram of an operation procedure, and structural diagrams are not intended to limit the scope of the disclosure. For example, all components, entities, or steps of operation described in the embodiments of the disclosure should not be interpreted as being essential components for the implementation of the disclosure, and the disclosure may be implemented within the scope that does not impair the essence of the disclosure, by including only some components. Also, the respective embodiments may be combined with each other as required and operated. For example, portions of the methods according to the disclosure may be combined with each other to enable a network entity and a terminal to operate.

The operations of the base station or terminal described above may be realized by providing memory device storing the corresponding program code in an arbitrary component in the base station or terminal device. For example, a controller of the base station or terminal device may execute the above-described operations by reading and executing the program code stored in the memory device by a processor or a central processing unit (CPU).

Various components and modules of the entity, base station, or terminal device described in this specification may be operated using a hardware circuit such as a combination of a complementary metal oxide semiconductor-based logic circuit, firmware, software, and/or hardware and firmware and/or software inserted into a machine readable medium. For example, various electrical structures and methods may be implemented using electrical circuits such as transistors, logic gates, and application specific integrated circuits.

In the case that components are implemented as software, a computer-readable storage medium storing one or more programs (e.g., software modules) may be provided. The one or more programs stored in the computer-readable storage medium are configured to be executable by one or more processors in an electronic device. The one or more programs include instructions causing the electronic device to execute the methods according to embodiments disclosed in claims or specification of the disclosure.

The programs (e.g., software modules or software) may be stored in RAM, non-volatile memory including flash memory, ROM, electrically erasable programmable read only memory (EEPROM), a magnetic disc storage device, a CD-ROM, a DVD, another type of optical storage device, or a magnetic cassette. Alternatively, the programs may be stored in memory including a combination of some or all of the above-mentioned memory devices. In addition, each constituent memory may be included by a plural number.

In addition, the programs may also be stored in an attachable storage device which is accessible through a communication network such as the Internet, an intranet, a local area network (LAN), a wide LAN (WLAN), a storage area network (SAN), or a combination thereof. The storage device may be connected through an external port to an apparatus performing the embodiments of the disclosure. Also, a separate storage device on the communication network may also be connected to the apparatus performing the embodiments of the disclosure.

In the above-described particular embodiments of the disclosure, components included in the disclosure are expressed in a singular or plural form according to the particular embodiments of the disclosure. However, the singular or plural form is appropriately selected for convenience of explanation and the disclosure is not limited thereto. As such, a component expressed in a plural form may also be constituted as a single component, and a component expressed in a singular form may also be configured as plural components.

Although specific embodiments have been described in the detailed description of the disclosure, various modifications are possible without departing from the scope of the disclosure. Therefore, the scope of the disclosure should not be limited to the described embodiments and should be determined by the claims described below as well as the claims and equivalents. For example, it is obvious to those skilled in the art that other modifications based on the technical spirit of the disclosure can be implemented. Also, the respective embodiments may be combined with each other as required and operated. For example, portions of the methods proposed in the disclosure may be combined with each other to enable a base station and a terminal to operate. Although the embodiments have been described based on 5G and the NR system, modified examples based on the technical spirit of the embodiments may also be carried out in other systems such as long term evolution (LTE), LTE advanced (LTE-A), LTE-A-Pro systems, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory, such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a session management function (SMF) in a wireless communication system, the method comprising:
receiving, from a united data management (UDM), a list of user plane function (UPF) functionality components;
selecting a UPF based on the list of UPF functionality components; and
transmitting, to the selected UPF, a session establishment or modification request message.

2. The method of claim 1, further comprising:
receiving, from an access and mobility management function (AMF), a protocol data unit (PDU) session create request message including a requested list of user plane function (UPF) functionality components,
wherein the selecting the UPF is performed further based on the requested list of UPF functionality components.

3. The method of claim 2, wherein the PDU session create request message includes information on mandatory or optional status for each UPF functionality in the requested list of UPF functionality components.

4. The method of claim 1,
wherein the session establishment is associated with a N4 session, and
wherein the session establishment or modification request message includes an activate list of UPF functionalities or a list of deactivate list of UPF functionalities.

5. The method of claim 1, wherein the session establishment or modification request message includes indication of activation or deactivation of UPF functionalities.

6. The method of claim 1, further comprising:
establishing, with a policy control function (PCF), a SM policy association;
transmitting, to the PCF, a request message for default policy and charging control (PCC) rules including the list of UPF functionality components; and
receiving, from the PCF, the PCC rules,
wherein the PCC rule are determined based on the list of UPF functionality components.

7. A method performed by an access and mobility management function (AMF) in a wireless communication system, the method comprising:
receiving, from a user equipment (UE), a protocol data unit (PDU) session establishment request message including a requested list of user plane function (UPF) functionality components;
selecting a session management function (SMF) based on a requested list of UPF functionality components and a list of supported UPF functionalities;
transmitting, to the selected SMF, a packet data unit (PDU) session create request message including the requested list of UPF functionality components; and
receiving, from the selected SMF, a PDU session create response message.

8. The method of claim 7, wherein the PDU session create request message includes information on mandatory or optional status for each UPF functionality in the requested list of UPF functionality components.

9. The method of claim 7, wherein the PDU session create response message includes a PDU session rejection cause with information on at least one UPF functionality not allowed.

10. A session management function (SMF) in a wireless communication system, the SMF comprising:
a transceiver; and
a controller configured to:
receive, from a united data management (UDM), a list of user plane function (UPF) functionality components,
select a UPF based on the list of UPF functionality components, and
transmit, to the selected UPF, a session establishment or modification request message.

11. The SMF of claim 10,
wherein the controller is further configured to:
receive, from an access and mobility management function (AMF), a protocol data unit (PDU) session create request message including a requested list of user plane function (UPF) functionality components,
wherein the UPF is selected further based on the requested list of UPF functionality components.

12. The SMF of claim 10, wherein the PDU session create request message includes information on mandatory or optional status for each UPF functionality in the requested list of UPF functionality components.

13. The SMF of claim 10,
wherein the session establishment is associated with a N4 session, and
wherein the session establishment or modification request message includes an activate list of UPF functionalities or a list of deactivate list of UPF functionalities.

14. The SMF of claim 10,
wherein the controller is further configured to:
establish, with a policy control function (PCF), a SM policy association,
transmit, to the PCF, a request message for default policy and charging control (PCC) rules including the list of UPF functionality components, and
receive, from the PCF, the PCC rules,
wherein the PCC rule are determined based on the list of UPF functionality components.

15. An access and mobility management function (AMF) in a wireless communication system, the AMF comprising:
a transceiver; and
a controller configured to:
receive, from a user equipment (UE), a protocol data unit (PDU) session establishment request message including a requested list of user plane function (UPF) functionality components,
select a session management function (SMF) based on a requested list of UPF functionality components and a list of supported UPF functionalities,
transmit, to the selected SMF, a packet data unit (PDU) session create request message including the requested list of UPF functionality components, and
receive, from the selected SMF, a PDU session create response message.

16. The AMF of claim 15, wherein the PDU session create request message includes information on mandatory or optional status for each UPF functionality in the requested list of UPF functionality components.

17. The AMF of claim 15, wherein the PDU session create response message includes a PDU session rejection cause with information on at least one UPF functionality not allowed.
